(19) United States
(12) Patent Application Publication
(10) Pub. No.: US 2010/0254723 A1
(43) Pub. Date: Oct. 7, 2010

(54) EXPOSURE HEAD, EXPOSURE HEAD CONTROL METHOD, AND IMAGE FORMING APPARATUS

(75) Inventor: Hiroshi Tanaka, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/750,605

(22) Filed: Mar. 30, 2010

(30) Foreign Application Priority Data
Apr. 1, 2009 (JP) 2009-088728

(51) Int. Cl. G03G 15/043

(52) U.S. Cl. 399/51; 347/256

(57) ABSTRACT

An exposure head includes: a light-emitting element; an image formation optical system that forms an image of light from the light-emitting element; multiple reference elements disposed relative to the light-emitting element; and a control unit that controls the light emission of the light-emitting element and extinguishes the reference elements during a latent image formation operation. The control unit finds the degree of decay of the light-emitting element based on the light amounts of the light-emitting element and the multiple reference elements at a time when the latent image formation operation is not being carried out, and controls the light amount of the light-emitting element during the latent image formation operation based on the degree of decay.

### BACKGROUND

1. Technical Field

The present invention relates to an exposure head that forms an image of light from a light-emitting element into an image using an image formation optical system, a control method for such an exposure head, and an image forming apparatus that employs such an exposure head.

2. Related Art

As an example of such an exposure head, JP-A-2008-36937 discloses an exposure head having a single image formation optical system relative to multiple light-emitting elements. The image formation optical system forms an image of light from the multiple light-emitting elements corresponding to the image formation optical system. An exposure target surface is then exposed with the light that has been formed into an image.

Meanwhile, it has been known for some time that light-emitting elements decay with repeated light emissions, and the amount of light emitted by the light-emitting elements drops as a result. When such a drop in the light amount occurs, there is a risk that the exposure head can no longer execute favorable exposure operations. In response to this, JP-A-2004-82330 proposes a light amount control technique that realizes favorable exposure operations regardless of decay in the light-emitting elements. With this light amount control technique, the light-emitting elements are sequentially caused to emit light during an examination prior to shipping the exposure head, and the light from each light-emitting element is measured by a light amount sensor. Furthermore, a light amount measurement similar to that performed in the pre-shipping measurement is carried out after the exposure head has been shipped as well, between, for example, exposure operations, when the power is turned on, and so on. The degree to which the light-emitting elements have decayed can be found based on the light amounts measured before and after the exposure head was shipped. Specifically, the ratio between the measured light amounts before and after shipping (a “correction coefficient” in JP-A-2004-82330) is measured. Controlling the light amounts of the light-emitting elements based on the ratio measured in this manner makes it possible to make the light amounts of the light-emitting elements uniform regardless of the decay thereof and achieve favorable exposure operations as a result.

However, the light amount of a light-emitting element also fluctuates due to changes in temperature. Accordingly, if the temperature of a light-emitting element changes between the pre-shipping light amount measurement and the post-shipping light amount measurement, the amount of light emitted by that light-emitting element will change due not only to decay but due also to the temperature change. As a result, there have been cases where the degree of decay found based on the pre- and post-shipping light amount measurements is affected by a change in temperature, making it difficult to accurately obtain the degree of decay. In such a case, light amount fluctuation caused by decay cannot be properly controlled, leading to the possibility that favorable exposure operations cannot be executed.

### SUMMARY

An advantage of some aspects of the invention is to provide a technique that enables favorable exposure operations to be executed by suppressing fluctuations in the light amounts of light-emitting elements caused by decay therein.

### First Aspect

An exposure head according to a first aspect of the invention includes a light-emitting element, an image formation optical system that forms an image of light from the light-emitting element, multiple reference elements disposed relative to the light-emitting element, and a control unit that controls the light emission of the light-emitting element and extinguishes the reference elements during a latent image formation operation. The control unit finds the degree of decay of the light-emitting element based on the light amounts of the light-emitting element and the multiple reference elements at a time when the latent image formation operation is not being carried out, and controls the light amount of the light-emitting element during the latent image formation operation based on the degree of decay.

### Second Aspect

An exposure head according to a second aspect of the invention is the exposure head according to the first aspect, where the exposure head includes multiple light-emitting elements, the multiple light-emitting elements being disposed across a distance that is longer in a first direction than in a second direction and being disposed symmetrically; and the multiple reference elements are disposed on the outer sides of corresponding light-emitting elements in the first direction, and are disposed symmetrically relative to the center of symmetry of the multiple light-emitting elements. According to these aspects of the invention, the reference elements and multiple light-emitting elements are advantageous in terms of being placed approximately at the same temperature, thus making it possible to find the degree of decay of the light-emitting elements with more accuracy. As a result, the exposure head can execute favorable exposure operations.

### Third Aspect

An exposure head according to a third aspect of the invention is the exposure head according to the above aspects, where the light-emitting element and the reference elements are organic EL elements. The light amounts of organic EL elements fluctuate depending on decay and changes in temperature, and this aspect of the invention is suited for accurately finding the degree of decay in the light-emitting element and realizing favorable exposure operations thereby.

### Fourth Aspect

A control method for an exposure head according to a fourth aspect of the invention includes: causing a light-emitting element and multiple reference elements disposed in the exposure head to emit light, and finding the degree of decay of the light-emitting element based on the light amounts of the light-emitting element and the multiple reference elements; and executing a latent image formation operation, in which light from the light-emitting element is formed by an image formation optical system and a latent image is formed upon a latent image bearing member, while controlling the light amount of the light-emitting element based on the degree of decay, and extinguishing the multiple reference elements during the latent image formation operation.

### Fifth Aspect

An image forming apparatus according to a fifth aspect of the invention includes: a latent image bearing member; an exposure head including a light-emitting element, an image formation optical system that forms an image of light from the light-emitting element and exposes the latent image bearing member, and multiple reference elements disposed relative to the light-emitting element; and a control unit that controls the light emission of the light-emitting element during a latent image formation operation in which a latent image is formed on the latent image bearing member and extinguishes the multiple reference elements during the latent image formation operation. The control unit finds the degree of decay of the light-emitting element based on the light amounts of the light-emitting element and the multiple reference elements which are caused to emit light at a time when the latent image formation operation is not being carried out, and controls the light amount of the light-emitting element during the latent image formation operation based on the degree of decay.

According to the invention (exposure head, control method for an exposure head, and image forming apparatus) configured in this manner, a latent image formation operation (exposure operation) is executed by forming an image of light from multiple light-emitting elements using an image formation optical system. The amount of light from the light-emitting elements applied to the latent image formation operation is influenced both by decay caused by repeated latent image formation operations, and by temperature. Accordingly, as described above, there have been situations where the degree of decay of a light-emitting element cannot be accurately found. In response to this, the invention obtains the degree of decay of a light-emitting element based on the light amounts of multiple reference elements and multiple light-emitting elements. The multiple reference elements are provided relative to the multiple light-emitting elements, and are under approximately the same temperature as the multiple light-emitting elements. Furthermore, the reference elements are extinguished during the latent image formation operations, and thus do not experience decay due to the latent image formation operations. In other words, by using the light amounts of the reference elements, which are under approximately the same temperature as the multiple light-emitting elements and do not experience decay, the invention enables the degree of decay of each of the multiple light-emitting elements to be found with accuracy while also suppressing the influence of temperature. Accordingly, controlling the light amounts of the light-emitting elements based on these decay rates makes it possible for the exposure head to suppress fluctuations in the light amounts of the light-emitting elements caused by decay and execute favorable exposures. Furthermore, using such an exposure head makes it possible for the image forming apparatus to form a favorable image.

Meanwhile, the control method for an exposure head can be configured in the following manner. That is, the control method for an exposure head can be configured so that the degree of decay of a light-emitting element is found based on the light amounts of a light-emitting element caused to emit light and multiple reference elements, and the light amounts of a light-emitting element caused to emit light and the multiple reference elements as stored in a storage unit. Using such a configuration makes it possible to accurately obtain the degree of decay of a light-emitting element while also suppressing the influence of temperature, even in the case where the temperature differs between when the light amounts stored in the storage unit were obtained and when the multiple light-emitting elements and multiple reference elements are caused to emit light.

### BRIEF DESCRIPTION OF THE DRAWINGS

The invention will be described with reference to the accompanying drawings, wherein like numbers reference like elements.

FIG. 1 is a schematic diagram illustrating an example of an image forming apparatus provided with a line head.

FIG. 2 is a block diagram illustrating the electrical configuration of an image forming apparatus.

FIG. 3 is a perspective view illustrating an outline of a line head that can be applied in the invention.

FIG. 4 is a cross-section illustrating the line head shown in FIG. 3 along the IV-IV line.

FIGS. 5A and 5B illustrate the configuration of a light-emitting element group; FIG. 5A is a plan view thereof, and FIG. 5B is a diagram illustrating temperatures within the light-emitting element group.

FIG. 6 is a plan view illustrating the configuration of the rear surface of a head substrate.

FIG. 7 is a plan view illustrating the configuration of a lens array.

FIG. 8 is a cross-section of a lens array, a head substrate, and so on, viewed in the lengthwise direction thereof.

FIG. 9 is a block diagram illustrating the configuration of a light emission control module.

FIG. 10 is a diagram illustrating spot latent image formation operations performed by a line head.

FIG. 11 is a flowchart illustrating a pre-shipping light amount measurement executed prior to shipping a line head.

FIG. 12 is a flowchart illustrating decay rate identification executed at a predetermined timing following shipping.

FIG. 13 is a diagram illustrating temperatures within a light-emitting element group for individual rows within the light-emitting element group.

FIG. 14 is a diagram illustrating temperatures within a light-emitting element group for individual columns within the light-emitting element group.

FIG. 15 is a plan view illustrating another example of a state in which reference elements are disposed.

### DESCRIPTION OF EXEMPLARY EMBODIMENTS

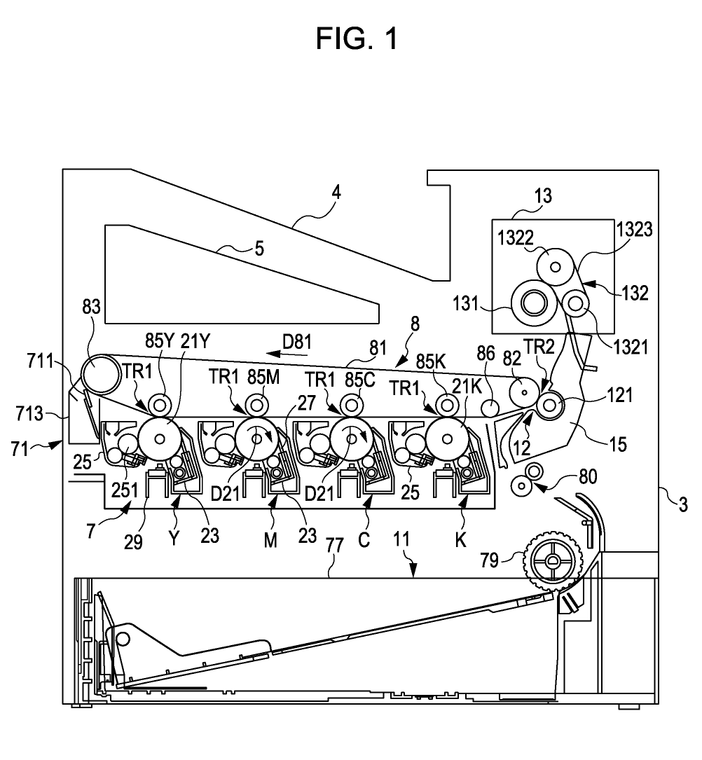

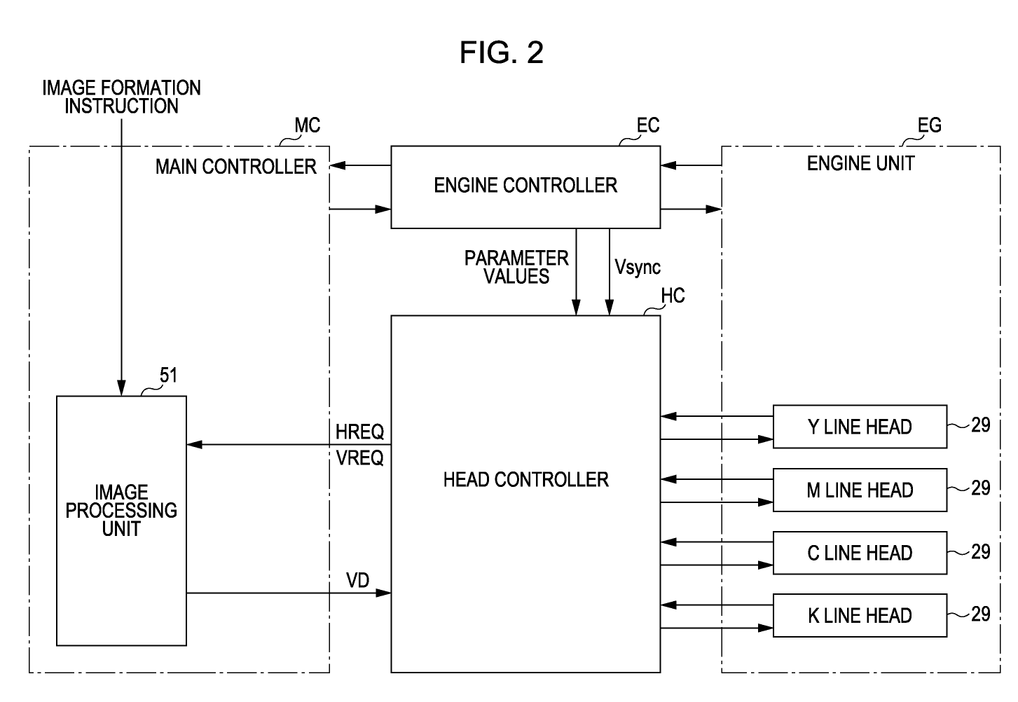

FIG. 1 is a schematic diagram illustrating an example of an image forming apparatus provided with a line head according to an embodiment of the invention. FIG. 2 is a block diagram illustrating the electrical configuration of the image forming apparatus illustrated in FIG. 1. This apparatus is an image forming apparatus capable of selectively executing a color mode, in which a color image is formed by superimposing four colors of toner, or black (K), cyan (C), magenta (M), and yellow (Y), or a monochromatic mode, in which a monochromatic image is formed using only black (K) toner. Note that FIG. 1 is a diagram illustrating the execution of the color mode.

As shown in FIG. 2, with this image forming apparatus, when a main controller MC including a CPU, a memory, and the like is provided with an image formation instruction from an external device such as a host computer, the main controller MC supplies a control signal to an engine controller EC and provides video data VD corresponding to the image formation instruction to a head controller HC. The head controller HC controls line heads 29 corresponding to each color based on the video data VD from the main controller MC and a vertical synchronization signal Vsync and parameter values from the engine controller EC. Accordingly, an engine unit EG executes a predetermined image forming operation, thereby forming an image corresponding to the image formation instruction on a sheet such as copy paper, transfer paper, form paper, or a transparent sheet for use in an OHP.

An electrical equipment box 5 including a power source circuit board, the main controller MC, the engine controller EC, and the head controller HC is provided within a housing body 3 with which the image forming apparatus illustrated in FIG. 1 is provided. Furthermore, an image forming unit 7, a transfer belt unit 8, and a paper supply unit 11 are also disposed within the housing body 3. Meanwhile, a secondary transfer unit 12, a fixing unit 13, and a sheet guide member 15 are disposed within the housing body 3 on the right side shown in FIG. 1. Note that the paper supply unit 11 is configured so as to be removable from the apparatus body 1. The paper supply unit 11 and the transfer belt unit 8 are also configured so as to be removable for maintenance or replacement.

The image forming unit 7 includes four image forming stations, or image forming stations Y (for yellow), M (for magenta), C (for cyan), and K (for black), that form images of multiple different colors. The image forming stations Y, M, C, and K are also provided with cylindrical photosensitive drums 21 (21Y, 21M, 21C, and 21K), each with a surface of a predetermined length in the main scanning direction MD. Each image forming station Y, M, C, and K forms a toner image of its corresponding color on the surface of its corresponding photosensitive drum 21. Each photosensitive drum 21 is disposed so its axial direction is parallel or approximately parallel to the main scanning direction MD. Furthermore, the photosensitive drums 21 are respectively connected to dedicated driving motors, and are rotationally driven at a predetermined speed in the direction of a rotational direction D21 indicated by arrows shown in FIG. 1. Through this, the surface of each photosensitive drum 21 is transported in the sub scanning direction SD, which is orthogonal or approximately orthogonal relative to the main scanning direction MD. Meanwhile, a charging unit 23, a line head 29, a developing unit 25, and a photosensitive member cleaner 27 are disposed in the periphery of each photosensitive drum 21, along the rotational direction thereof. Discharge operations, latent image forming operations, toner developing operations, and so on are executed by these functional units. Accordingly, when executing the color mode, a color image is formed by superimposing toner images formed by all of the image forming stations Y, M, C, and K on a transfer belt 81 provided in the transfer belt unit 8, whereas when executing the monochromatic mode, a monochromatic image is formed using only a toner image formed by the image forming station K. Note that in FIG. 1, the configurations of the image forming stations Y, M, C, and K in the image forming unit 7 are identical, and thus for the sake of simplicity, reference numerals have been given only to some of the image forming stations and have been omitted with respect to the other image forming stations.

The charging unit 23 includes a charge roller whose surface is configured of an elastic rubber. The charge roller is configured so as to make contact with the surface of the photosensitive drum 21 at a charge position and rotate in accordance with the photosensitive drum 21, and rotates in accordance with the rotational movement of the photosensitive drum 21 at the same circumferential speed in the direction of the photosensitive drum 21. Furthermore, this charge roller is connected to a charge bias generation unit (not shown), and upon being supplied with a charge bias from the charge bias generation unit, charges the surface of the photosensitive drum 21 at the charge position where the charge unit 23 and the photosensitive drum 21 make contact with each other.

Each line head 29 includes multiple light-emitting elements, and is disposed with an interval between it and the corresponding photosensitive drum 21. The light-emitting elements irradiate the surface of the photosensitive drum 21 that has been charged by the charge unit 23 with light, thereby forming an electrostatic latent image upon that surface.

The developing unit 25 includes a developing roller 251, and toner is held on the surface thereof. A developing bias applied to the developing roller 251 by a developing bias generation unit (not shown) electrically connected to the developing roller 251 causes charged toner to move from the developing roller 251 to the photosensitive drum 21 at a developing position at which the developing roller 251 and the photosensitive drum 21 make contact with each other, thereby visualizing the electrostatic latent image formed by the line head 29.

The toner image visualized in this manner at the stated developing position is transported in the direction of the rotational direction D21 of the photosensitive drum 21, and then undergoes a primary transfer onto the transfer belt 81 at a primary transfer position TR1, described later, where the transfer belt 81 makes contact with each photosensitive drum 21.

Meanwhile, in this embodiment, a photosensitive member cleaner 27 that makes contact with the surface of the photosensitive drum 21 is provided on the downstream side of the primary transfer position TR1 and the upstream side of the charging unit 23 in the rotational direction D21 of the photosensitive drum 21. By making contact with the surface of the photosensitive drum 21, this photosensitive member cleaner 27 removes toner remaining on the surface of the photosensitive drum 21 following the primary transfer.

The transfer belt unit 8 includes a driving roller 82, a slave roller 83 (a blade-opposed roller) provided to the left of the driving roller 82 in FIG. 1, and the transfer belt 81, which is stretched across these rollers and which is cyclically driven in the direction of the arrow D81 in FIG. 1 (the transport direction). Furthermore, the transfer belt unit 8 includes four primary transfer rollers 85Y, 85M, 85C, and 85K, which are disposed on the inner side of the transfer belt 81 so as to oppose the photosensitive drums 21 in the image forming stations Y, M, C, and K, respectively, when photosensitive member cartridges are installed. Each of these primary transfer rollers 85 are electrically connected to respective primary transfer bias generation units (not shown). When executing the color mode, all of the primary transfer rollers 85Y, 85M, 85C, and 85K shown in FIG. 1 are positioned toward the image forming stations Y, M, C, and K, respectively, thereby causing the transfer belt 81 to push toward and make contact with the photosensitive drums 21 in the image forming stations Y, M, C, and K, thus forming the primary transfer position TR1 between each photosensitive drum and the transfer belt 21. By applying a primary transfer bias to the primary transfer rollers 85 from the stated primary transfer bias generation units at an appropriate timing, the toner images formed upon the surfaces of the photosensitive drums 21 are transferred to the surface of the transfer belt 81 at the respective corresponding primary transfer positions TR1, thereby forming a color image.

On the other hand, when executing the monochromatic mode, of the four primary transfer rollers 85, the primary transfer rollers 85Y, 85M, and 85C used in the color mode are distanced from the image forming stations Y, M, and C that the corresponding primary transfer rollers oppose, and only the primary transfer roller 85K used in the monochromatic mode is brought into contact with the image forming station K, thereby causing only the monochromatic image forming station K to make contact with the transfer belt 81. As a result, a primary transfer position TR1 is formed only between the primary transfer roller 85K and image forming station K. By applying a primary transfer bias to the primary transfer roller 85K from the primary transfer bias generation unit at an appropriate timing, the toner image formed upon the surface of the photosensitive drum 21K is transferred to the surface of the transfer belt 81 at the primary transfer position TR1, thereby forming a monochromatic image.

Furthermore, the transfer belt unit 8 includes a downstream guide roller 86 disposed on the downstream side of the primary transfer roller 85K and the upstream side of the driving roller 82. The downstream guide roller 86 is configured so as to make contact with the transfer belt 81 at the internal common tangent between the primary transfer rollers 85 and the photosensitive drums 21 at the primary transfer positions TR1 formed where the primary transfer rollers 85 make contact with their corresponding photosensitive drums 21 of the image forming stations Y, M, C, and K.

The driving roller 82 cyclically drives the transfer belt 81 in the direction of the arrow D81 shown in FIG. 1, and also functions as a backup roller for a secondary transfer roller 121. A rubber layer approximately 3 mm thick and having a volume resistivity of no more than 1000 kΩ/cm is formed on the circumferential surface of the driving roller 82, and the driving roller 82 is grounded via a metallic axis; thus the driving roller 82 functions as a conductive path for a secondary transfer bias supplied from a secondary transfer bias generation unit (not shown) via the secondary transfer roller 121. Providing the driving roller 82 with a high-friction and shock-absorbing rubber layer in this manner inhibits impact shock arising when a sheet enters into the area where the driving roller 82 and the secondary transfer roller 121 make contact with each other (a secondary transfer position TR2) from being transmitted to the transfer belt 81, thus making it possible to prevent image quality degradation.

The paper supply unit 11 is provided with a paper supply unit which includes a paper supply cassette 77 capable of holding a stack of sheets, and a pickup roller 79 that supplies sheets from the paper supply cassette 77, one sheet at a time. The sheets supplied from the paper supply unit by the pickup roller 79 are supplied to the secondary transfer position TR2 along the sheet guide member 15 after the supply timing of the sheets is adjusted by a resist roller pair 80.

The secondary transfer roller 121 is provided in a state in which it can be freely pressed against or removed from the transfer belt 81, and is driven so as to be pressed against or removed from the transfer belt 81 by a secondary transfer roller driving mechanism (not shown). The fixing unit 13 includes a rotatable heating roller 131 provided with a heating element such as a halogen heater, and a pressurizing unit 132 that applies pressure to the heating roller 131. The sheet onto which the image on that surface has undergone a secondary transfer is then guided by the sheet guide member 15 to a nip portion formed between the heating roller 131 and a pressure belt 1323 of the pressurizing unit 132, where the image is heat-fixed at a predetermined temperature. The pressurizing unit 132 is configured of two rollers 1321 and 1322, and the pressure belt 1323 that is stretched thereacross. Of the surface of the pressure belt 1323, the area that is stretched between the two rollers 1321 and 1322 is pressed against the circumferential surface of the heating roller 131, thereby configuring the nip portion between the heating roller 131 and the pressure belt 1323 to cover a wider surface area on the heating roller 131. Sheets that have undergone this fixing process are then transported to a discharge tray 4 provided in the upper surface of the housing body 3.

Meanwhile, with this apparatus, a cleaner unit 71 is disposed opposite to the blade-opposed roller 83. The cleaner unit 71 includes a cleaning blade 711 and a discarded toner box 713. The tip portion of the cleaning blade 711 makes contact with the blade-opposed roller 83 via the transfer belt 81, and removes toner, foreign objects such as paper particles, and the like that have remained on the transfer belt 81 following the secondary transfer. Foreign objects removed in this manner are collected in the discarded toner box 713.

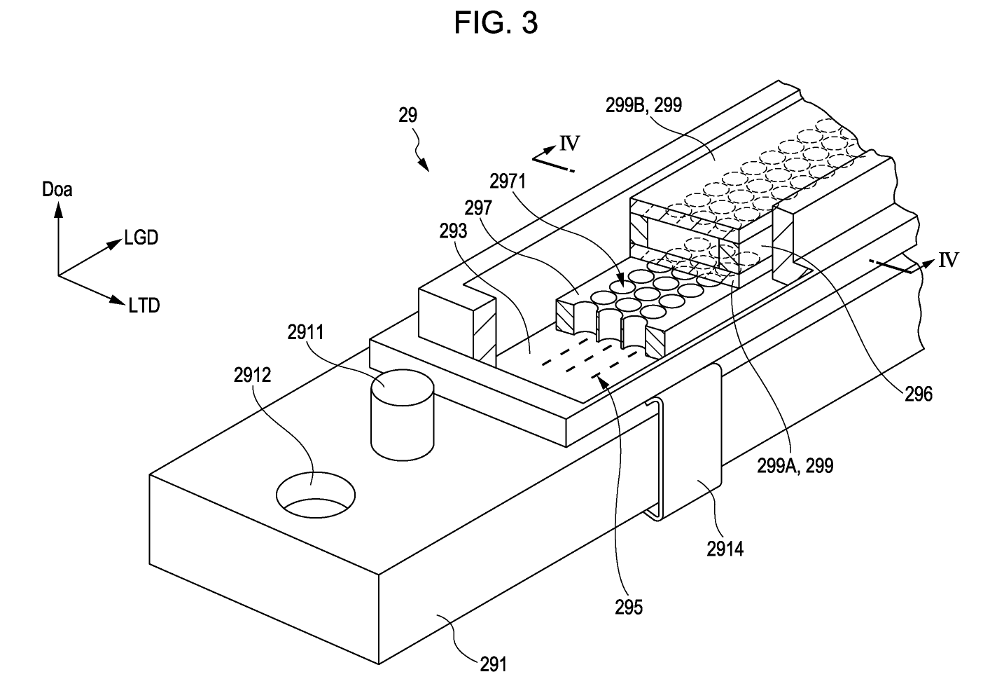

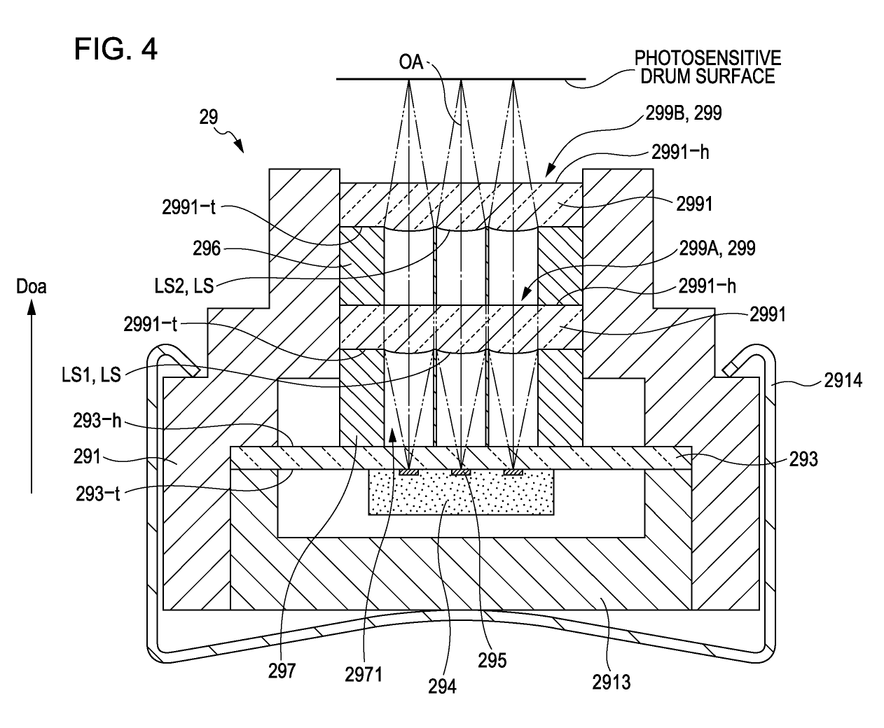

In the foregoing descriptions, the main scanning direction MD is a first direction, and the sub scanning direction SD is a second direction; the first direction and the second direction are orthogonal or approximately orthogonal to each other. FIG. 3 is a perspective view illustrating an outline of the line head according to this embodiment. FIG. 4, meanwhile, is a cross-section illustrating the line head shown in FIG. 3 along the IV-IV line, and is a cross-section that is parallel to the optical axis OA of a lens. Note that the IV-IV line is parallel or approximately parallel to a light-emitting element group column 295C, a lens column LSC, and so on mentioned later. The lengthwise direction LGD of the line head 29 is parallel or approximately parallel to the main scanning direction MD, whereas the widthwise direction LTD of the line head 29 is parallel or approximately parallel to the sub scanning direction SD. Note that the lengthwise direction LGD and the widthwise direction LTD are orthogonal or approximately orthogonal to each other. As will be described later, with this line head 29, multiple light-emitting elements are formed in a head substrate 293, and the light-emitting elements emit light beams toward the surface of the photosensitive drum 21. Accordingly, in this specification, a direction that is orthogonal to the lengthwise direction LGD and widthwise direction LTD and that is the direction moving from the light-emitting elements toward the surface of the photosensitive drum will be referred to as the light beam travel direction Doa. This light beam travel direction Doa is parallel or approximately parallel to the optical axis OA of the lens.

The line head 29 includes a case 291, and a positioning pin 2911 and a screw insertion hole 2912 are provided at both ends of the case 291 in the lengthwise direction LGD. The line head 29 is positioned relative to the photosensitive drum 21 by fitting the positioning pin 2911 into a positioning hole (not shown) that has been opened in a photosensitive member cover (not shown) that covers the photosensitive drum 21 and that has been positioned relative to the photosensitive drum 21. Furthermore, screwing an anchoring screw into a screw hole (not shown) in the photosensitive member cover via the screw insertion hole 2912, thereby anchoring the photosensitive member cover, anchors the line head 29 in a state in which it is positioned relative to the photosensitive drum 21.

The head substrate 293, a light-blocking member 297, and two lens arrays 299 (299A and 299B) are disposed within the case 291. The interior of the case 291 makes contact with the surface 293-h of the head substrate 293, whereas a rear cover 2913 makes contact with the rear surface 293-t of the head substrate 293. The rear cover 2913 is pressed into the case 291 via the head substrate 293 by an anchoring fixture 2914. In other words, the anchoring fixture 2914 exerts an elastic force that presses the rear cover 2913 toward the inside of the case 291 (the upward direction in FIG. 4), and pressing the rear cover in this manner using the elastic force closes the case in a light-proof manner (in other words, light is unable to escape from the interior of the case 291, and light is unable to penetrate into the interior of the case 291). Note that multiple anchoring fixtures 2914 are provided in multiple locations along the lengthwise direction LGD of the case 291.

Light-emitting element groups 295, in each of which multiple light-emitting elements have been grouped together, are provided on the rear surface 293-t of the head substrate 293. The head substrate 293 is formed of a light-transmissive member such as glass or the like, and light beams emitted by the light-emitting elements in the light-emitting element groups 295 are capable of passing through from the rear surface 293-t to the surface 293-h of the head substrate 293. The light-emitting elements are bottom emission-type organic EL (electroluminescence) elements, and are covered by a sealing member 294. When the light-emitting elements 2951 are driven by a current, they emit light beams of identical wavelengths. The light-emitting elements 2951 are so-called Lambertian surface light sources, and the light beams emitted from the light-emitting surface follow Lambert's cosine law.

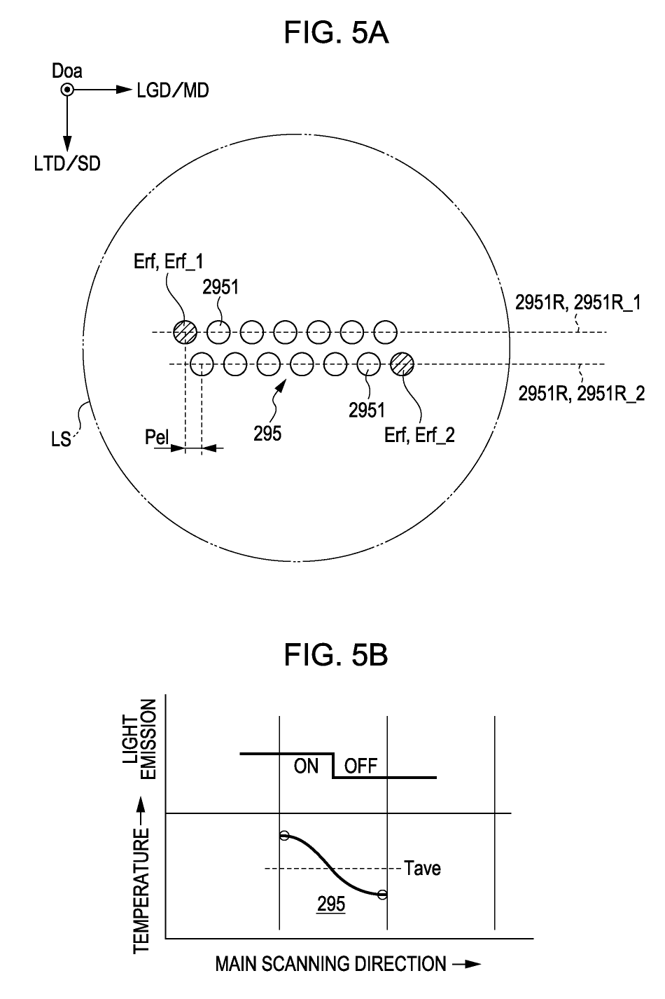

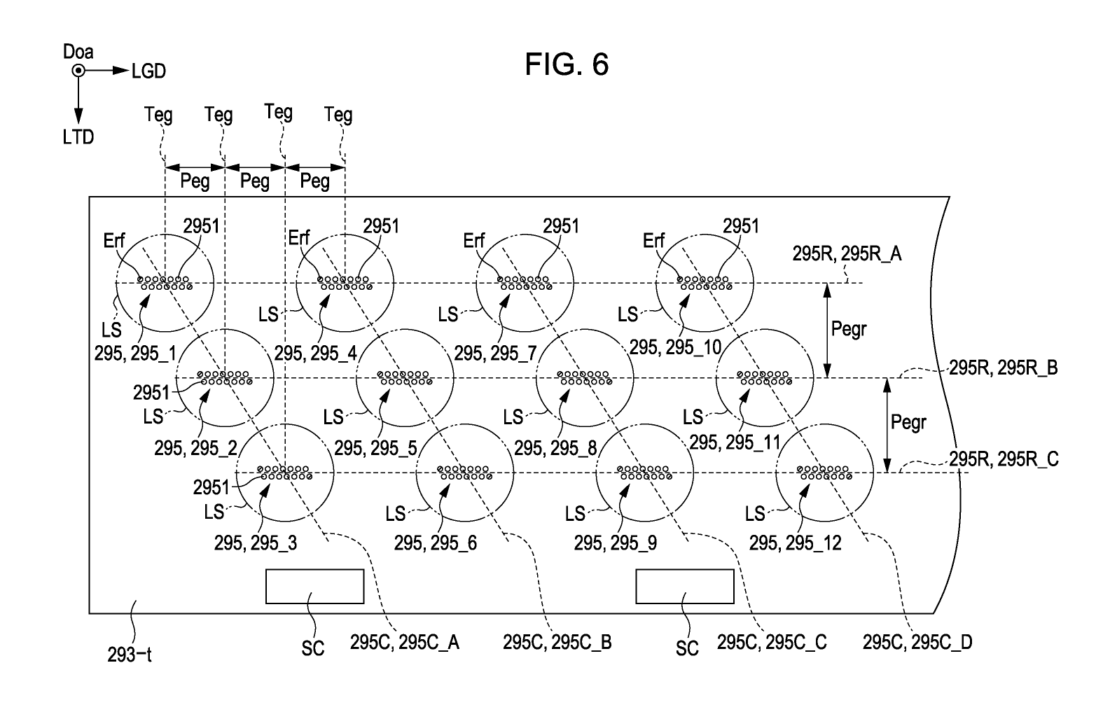

FIG. 5A is a plan view illustrating the configuration of a light-emitting element group provided on the rear surface of the head substrate, and FIG. 6 is a plan view illustrating the configuration of the rear surface of the head substrate; both of these drawings represent cases looking from the rear surface of the head substrate toward the front surface of the head substrate. Note that although lenses LS are indicated by dot-dash lines in these drawings, this is simply for illustrating the correspondence relationship between the light-emitting element groups 295 and the lenses LS, and does not indicate that the lenses LS are formed upon the head substrate rear surface 293-t. As shown in FIG. 5A, in this embodiment, light-emitting elements 2951 (white circles) for exposing the surface of the photosensitive drum 21 and reference elements Erf (hatched circles) not used in exposure operations are provided. A single light-emitting element group 295 is configured by grouping together twelve light-emitting elements 2951. To be more specific, a light-emitting element row 2951R is configured by arranging seven light-emitting elements 2951 in the lengthwise direction LGD at a pitch double a light-emitting element pitch Pel, and two light-emitting element rows 2951R_1 and 2951R_2 are disposed at different locations in the widthwise direction LTD. The two light-emitting element rows 2951R_1 and 2951R_2 are shifted relative to each other by an amount equivalent to the light-emitting element pitch Pel. Accordingly, each light-emitting element 2951 in the light-emitting element group 295 is provided at a different location in the lengthwise direction LGD. Furthermore, two reference elements Erf_1 and Erf_2 are disposed on the outer sides of the light-emitting element group 295 for each light-emitting element group 295. To be more specific, the reference element Erf_1 is located at one end (in FIG. 5, the left side) in the lengthwise direction LGD of the light-emitting element row 2951R_1 in the light-emitting element group 295. Meanwhile, the reference element Erf_2 is located at one end (in FIG. 5, the right side) in the lengthwise direction LGD of the light-emitting element row 2951R_2 in the light-emitting element group 295. Like the light-emitting elements 2951, the reference elements Erf are bottom emission-type organic EL elements. Furthermore, as shown in FIG. 6, multiple light-emitting element groups 295 are disposed two-dimensionally with intervals therebetween. Details are as follows.

Light-emitting element group columns 295C are configured by disposing three light-emitting element groups 295 at different locations each other in the widthwise direction LTD. In each light-emitting element group column 295C, the three light-emitting element groups 295 are disposed so as to be shifted relative to one another in the lengthwise direction LGD by an amount equivalent to a light-emitting element group pitch Peg. Multiple light-emitting element group columns 295C are arranged in the lengthwise direction LGD at a light-emitting element group column pitch (=Peg×3). In this manner, the light-emitting element groups 295 are provided at the light-emitting element group pitch Peg in the lengthwise direction LGD, and positions Teg of the light-emitting element groups 295 differ from each other in the lengthwise direction LGD.

Taking this from a different perspective, the light-emitting element groups 295 can be said to be arranged in the following manner. That is, on the rear surface 293-t of the head substrate 293, light-emitting element group rows 295R are configured by arranging multiple light-emitting element groups 295 in the lengthwise direction LGD, and three light-emitting element group rows 295R are provided in different positions from each other in the widthwise direction LTD. The three light-emitting element group rows 295R are provided at a light-emitting element group row pitch Pegr in the widthwise direction LTD. Furthermore, the light-emitting element group rows 295R are shifted relative to each other in the lengthwise direction LGD by an amount equivalent to the light-emitting element group pitch Peg. Accordingly, the multiple light-emitting element groups 295 are provided at the light-emitting element group pitch Peg in the lengthwise direction LGD, and positions Teg of the light-emitting element groups 295 differ from each other in the lengthwise direction LGD.

Here, the position Teg of a light-emitting element group 295 can be taken as the center of the light-emitting element group 295 when viewed from the light travel direction Doa. When viewing the multiple light-emitting elements 2951 in which a light-emitting element group 295 is configured from the light travel direction Doa, the center of that light-emitting element group 295 can be taken as the center of those multiple light-emitting elements 2951. Furthermore, the interval between the positions Teg of two adjacent light-emitting element groups 295 (for example, light-emitting element groups 295_1 and 295_2) in the lengthwise direction LGD can be taken as the light-emitting element group pitch Peg. Note that in FIG. 6, the positions Teg of the light-emitting element groups 295 in the lengthwise direction LGD are expressed by vertical lines descending from the lengthwise direction axis LGD in the positions of the light-emitting element groups 295.

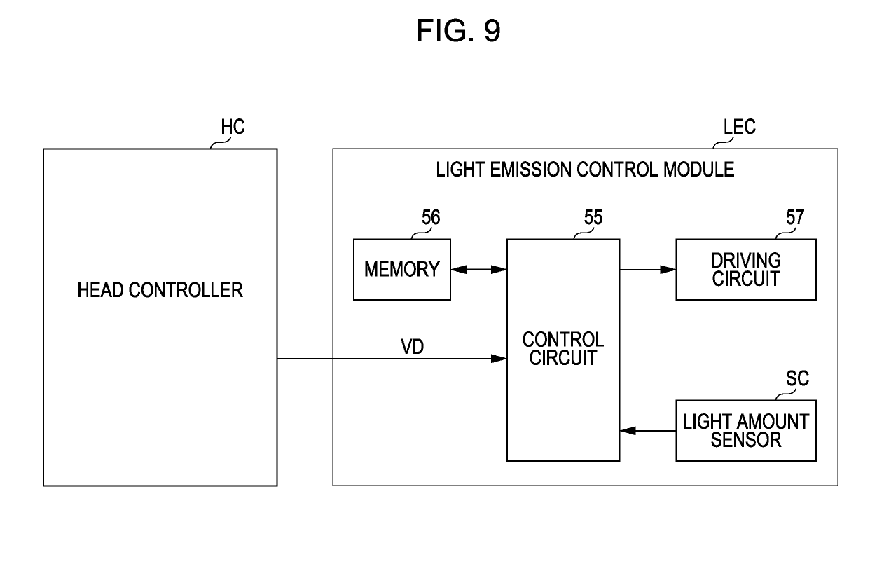

Multiple light amount sensors SC are arranged on the rear surface 293-t of the head substrate 293 in the lengthwise direction LGD. Each light amount sensor SC detects the light emitted by the light-emitting elements 2951, the light emitted by the reference elements Efr mentioned later, and so on. The detection values of the light amount sensors SC are then outputted to a light emission control module LEC, which will be described later (FIG. 9).

Descriptions will now be resumed from FIGS. 3 and 4. The light-blocking member 297 is disposed so as to make contact with the surface 293-h of the head substrate 293. Light guide holes 2971 are provided in the light-blocking member 297 for the multiple light-emitting element groups 295 (that is, light guide holes 2971 are provided on a one-on-one basis for the light-emitting element groups 295). Each light guide hole 2971 is formed in the light-blocking member 297 as a hole that passes therethrough in the light beam travel direction Doa. Furthermore, the two lens arrays 299 are disposed overlapping each other in the light beam travel direction Doa on the upper side of the light-blocking member 297 (the side opposite to the head substrate 293).

In this manner, the light-blocking member 297, in which a light guide hole 2971 is provided for each light-emitting element group 295, is disposed between the light-emitting element groups 295 and the lens arrays 299 in the light beam travel direction Doa. Accordingly, light beams exiting the light-emitting element groups 295 pass through the light guide holes 2971 corresponding to those light-emitting element groups 295 toward the lens arrays 299. To describe this from a different perspective, of the light beams emitted by a light-emitting element group 295, the light beams not proceeding toward the light guide hole 2971 corresponding to that light-emitting element group 295 are blocked by the light-blocking member 297. In this manner, all of the light emitted from a single light-emitting element group 295 proceeds toward the lens arrays 299 via the same light guide hole 2971, and interference between light beams emitted from different light-emitting element groups 295 is prevented by the light-blocking member 297.

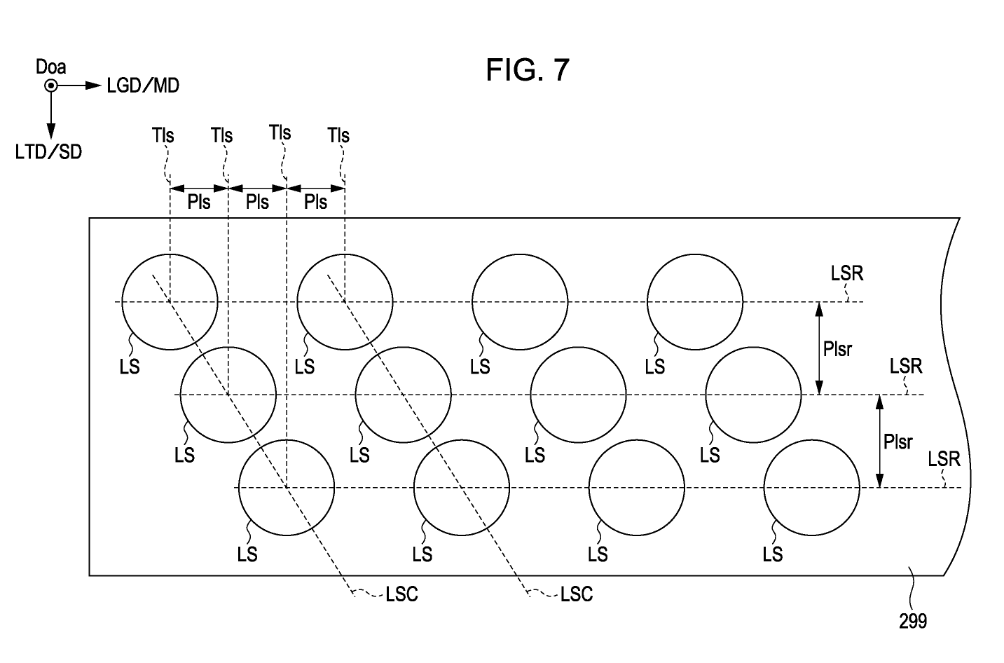

FIG. 7 is a plan view illustrating the configuration of a lens array, and represents a case looking at the lens array from the light beam travel direction Doa. Note that each lens LS in FIG. 7 is formed on the rear surface 2991-t of a lens array substrate 2991, and FIG. 7 illustrates the configuration of the lens array substrate rear surface 2991-t. In the same manner as shown in FIG. 6, with the lens array 299, a lens LS is provided for each light-emitting element group 295. In other words, in each lens array 299, multiple lenses LS are disposed two-dimensionally with an interval provided therebetween. Details are as follows.

Lens columns LSC are configured by disposing three lenses LS in different positions from each other in the widthwise direction LTD. Each lens column LSC is disposed so that the three lenses LS are shifted relative to each other by an amount equivalent to a lens pitch Pls in the lengthwise direction LGD. Multiple lens columns LSC are arranged in the lengthwise direction LGD at a lens column pitch (=Pls×3). In this manner, the lenses LS are provided at the lens pitch Pls in the lengthwise direction LGD, and the positions Tls of each of the lenses LS in the lengthwise direction LGD differ from each other.

Taking this from a different perspective, it can be said that the lenses LS are disposed in the following manner. That is, a lens row LSR is configured by arranging multiple lenses LS in the lengthwise direction LGD, and three lens rows LSR are provided in different positions from each other in the widthwise direction LTD. The three lens rows LSR are arranged in the widthwise direction LTD at a lens row pitch Plsr. Furthermore, the lens rows LSR are shifted relative to each other in the lengthwise direction LGD by an amount equivalent to the lens pitch Pls. Accordingly, the multiple lenses LS are provided at the lens pitch Pls in the lengthwise direction LGD, and the positions Tls of the lenses LS in the lengthwise direction LGD are different from each other. Note that in FIG. 7, the positions of the lenses LS are represented by the apexes of the lenses LS (in other words, the points of maximum sag), and the positions Tls of the lenses LS in the lengthwise direction LGD are expressed by vertical lines descending from the lengthwise direction axis LGD to the apexes of the lenses LS.

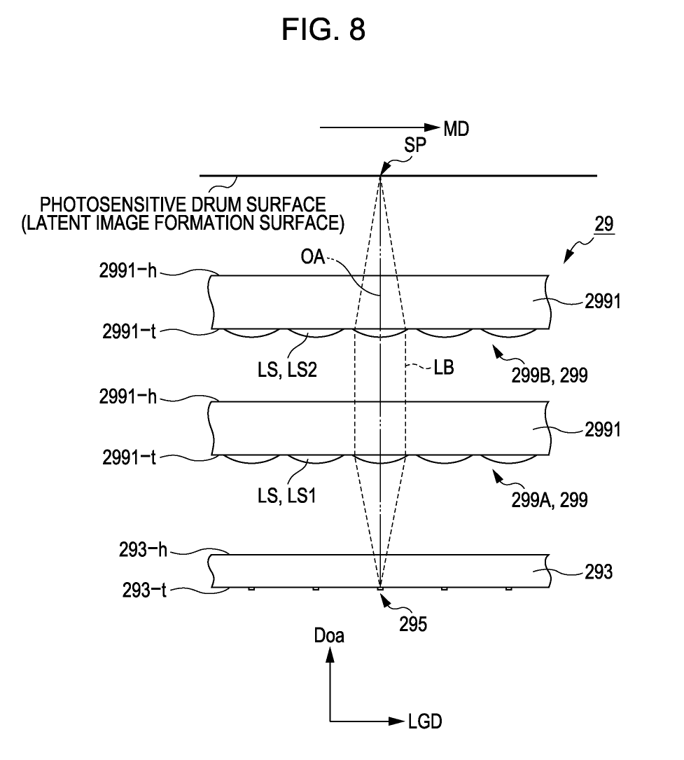

FIG. 8 is a cross-section of the lens arrays, the head substrate, and so on, viewed in the lengthwise direction thereof, and illustrates a lengthwise direction cross-section including the optical axis of lenses LS formed in the lens arrays. Each of the lens arrays 299 include a light-transmissive lens array substrate 2991 that is continuous in the lengthwise direction LGD. The lens array substrates 2991 are formed of glass that has a comparatively low linear expansion coefficient. Of the surface 2991-h and the rear surface 2991-t of each lens array substrate 2991, the lenses LS are formed on the rear surface 2991-t of the lens array substrate 2991. Each lens LS is formed of, for example, a light-curable resin.

With this line head 29, in order to increase the freedom of the optical design, two lens arrays 299 configured in this manner (that is, lens arrays 299A and 299B) are disposed overlapping each other in the light beam travel direction Doa. The two lens arrays 299A and 299B oppose each other with a base 296 provided therebetween (FIGS. 3 and 4); the base 296 functions to define the interval between the lens arrays 299A and 299B. In this manner, two lenses LS1 and LS2 arranged overlapping the light beam travel direction Doa are provided for each light-emitting element group 295 (FIGS. 3, 4, and 8). Here, the lenses LS of the lens array 299A on the upstream side in the light beam travel direction Doa are first lenses, or the lenses LS1, whereas the lenses LS of the lens array 299B on the downstream side in the light beam travel direction Doa are second lenses, or the lenses LS2.

A light beam LB emitted from a light-emitting element group 295 is projected by the two lenses LS1 and LS2 disposed opposite to that light-emitting element group 295, thereby forming a spot ST on the photosensitive drum surface (latent image formation surface). In other words, an image formation optical system is configured by the two lenses LS 1 and LS2, and the image formation optical system is disposed opposite to each light-emitting element group 295. The optical axis OA of the image formation optical system is parallel to the light travel direction Doa, and passes through the position central to the light-emitting element group 295. The image formation optical system has what is known as an inverse enlargement optical characteristic. In other words, the image formation optical system forms an inverted image, and the absolute value of the optical magnification of the image formation optical system is greater than 1.

The specific configurations of the line head 29 and an image forming apparatus provided with the line head 29 have been described thus far. Exposure operations performed by the line head 29 will be described next. The line head 29 exposes the surface of the photosensitive drum 21 based on the video data VD. The video data VD is generated by the main controller MC (FIG. 2). In other words, the main controller MC includes an image processing unit 51, and the image processing unit 51 carries out signal processing on image data contained in the image formation instruction from an external device, thereby generating the video data VD. The signal processing is executed on a single page's worth of image each time a vertical request signal VREQ is inputted from the head controller HC. Then, upon each reception of a horizontal request signal HREQ from the head controller HC, the image processing unit 51 outputs one line's worth of video data VD to the head controller HC.

The head controller HC generates the vertical request signal VREQ and the horizontal request signal HREQ based on the synchronization signal Vsync provided by the engine controller EC. Meanwhile, the head controller HC outputs the video data VD received from the main controller MC to the light emission control module LEC (FIG. 9) provided in the line head 29. A light emission control module LEC is provided for each of the line heads 29 for the four colors.

FIG. 9 is a block diagram illustrating the configuration of the light emission control module. The light emission control module LEC is configured of a control circuit 55 that controls the various portions of the light emission control module LEC, a driving circuit 57 that drives the light-emitting elements 2951, a light amount sensor SC (FIG. 6), and a memory 56. The control circuit 55 controls the driving of the light-emitting elements by the driving circuit 57 based on the video data VD received from the head controller HC. At this time, the control circuit 55 drives each light-emitting element 2951 based on the decay rate of the light-emitting elements 2951 found in advance and stored in the memory 56, thereby causing the light-emitting elements 2951 to emit an approximately uniform amount of light (a second process). Note that a method for identifying the decay rate of the light-emitting elements 2951 will be described later.

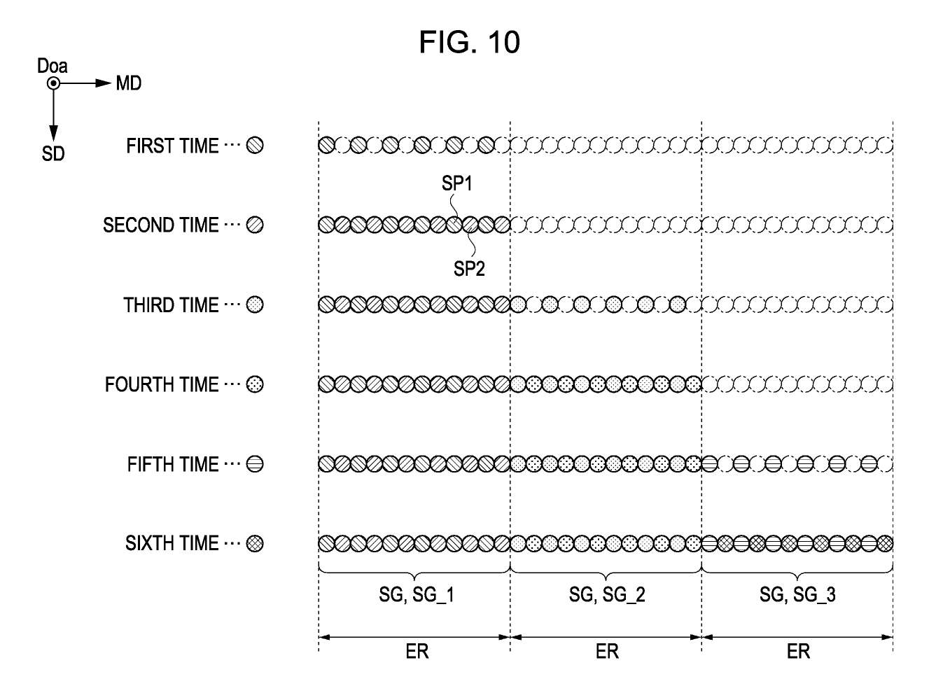

Incidentally, as shown in FIG. 6, in the line head 29, multiple light-emitting element groups 295 are arranged two-dimensionally. Accordingly, in order to properly form a latent image on the surface of the photosensitive drum 21, the head controller HC and the light emission control module LEC operate cooperatively to control the light emitted by the light-emitting element groups 295 in the following manner. FIG. 10 is a diagram illustrating spot latent image formation operations performed by the line head. Hereinafter, spot latent image formation operations performed by the line head 29 will be described with reference to FIGS. 5, 6, and 10. As an outline of these operations, each light-emitting element group 295 forms a spot group SG in exposure regions ER that are different from each other, thereby executing the latent image formation. With the latent image formation operations involved therewith, the head controller HC and the light emission control module LEC operate in cooperation so as to cause the light-emitting elements 2951 to emit light at a predetermined timing while the surface of the photosensitive drum 21 is transported in the sub scanning direction SD, thereby forming multiple spots SP in a row in the main scanning direction MD. Note that during these latent image formation operations, the reference elements Erf are extinguished. Detailed descriptions will be given hereinafter.

First, when the light-emitting element row 2951R_2 of the light-emitting element groups 295 (295_1, 295_4, and so on) that belong to the light-emitting element group row 295R_A furthest upstream in the widthwise direction LTD emit light, seven spots are formed as expressed by the hatching pattern indicated by “first time” in FIG. 10. Following the light-emitting element rows 2951R_2, the light-emitting element rows 2951R_1 emit light, thereby forming seven spots as expressed by the hatching pattern indicated by “second time” in FIG. 10. In this manner, two light-emitting elements 2951 disposed at the light-emitting element pitch Pel in the lengthwise direction LGD can form two adjacent spots in the main scanning direction MD (for example, spots SP1 and SP2). Here, the light emission is executed in order starting with the light-emitting element rows 2951R on the downstream side in the widthwise direction LTD because this corresponds to the inversion characteristics of the image formation optical system.

Next, the light-emitting element groups 295 (295_2 and so on) that belong to the light-emitting element group row 295R_B on the downstream side of the light-emitting element group row 295R_A in the widthwise direction LTD are caused to carry out the same light-emitting operations as the stated light-emitting element group row 295R_A, thereby forming spots as expressed by the hatching patterns indicated by “third time” and “fourth time” in FIG. 10. Furthermore, the light-emitting element groups 295 (295_3 and so on) that belong to the light-emitting element group row 295R_C on the downstream side of the light-emitting element group row 295R_B in the widthwise direction LTD are caused to carry out the same light-emitting operations as the stated light-emitting element group row 295R_A, thereby forming spots as expressed by the hatching patterns indicated by “fifth time” and “sixth time” in FIG. 10. Accordingly, multiple spots are formed in a row in the main scanning direction MD by executing the light emission operations for the first through sixth times.

One line's worth of a line latent image is formed in the main scanning direction MD by the light-emitting element groups 295_1, 295_2, 295_3, and so on respectively forming spot groups SG_1, SG_2, SG_3, and so on in a row in the main scanning direction MD. A two-dimensional electrostatic latent image can then be formed by sequentially forming line latent images as the surface of the photosensitive drum 21 moves in the sub scanning direction SD.

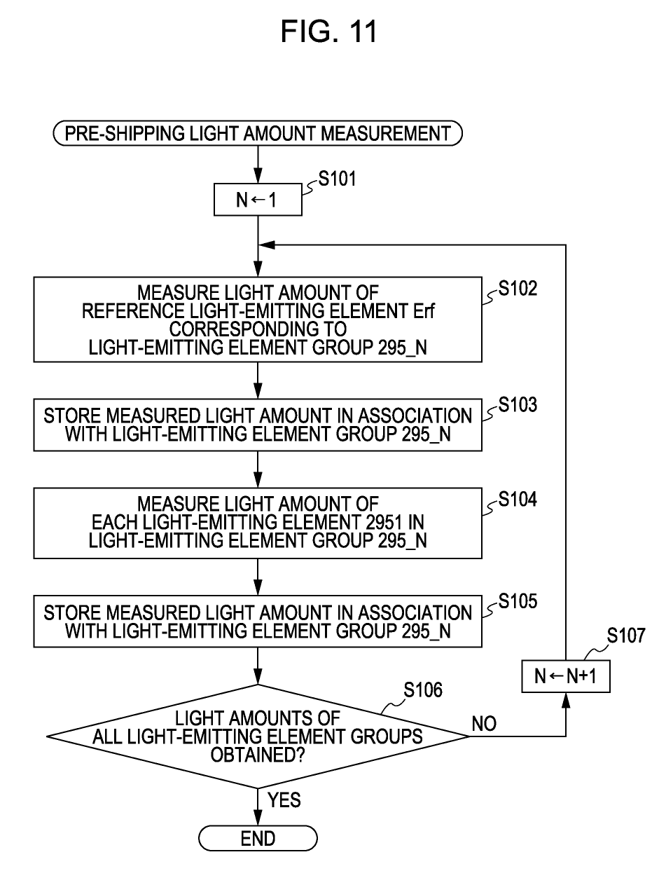

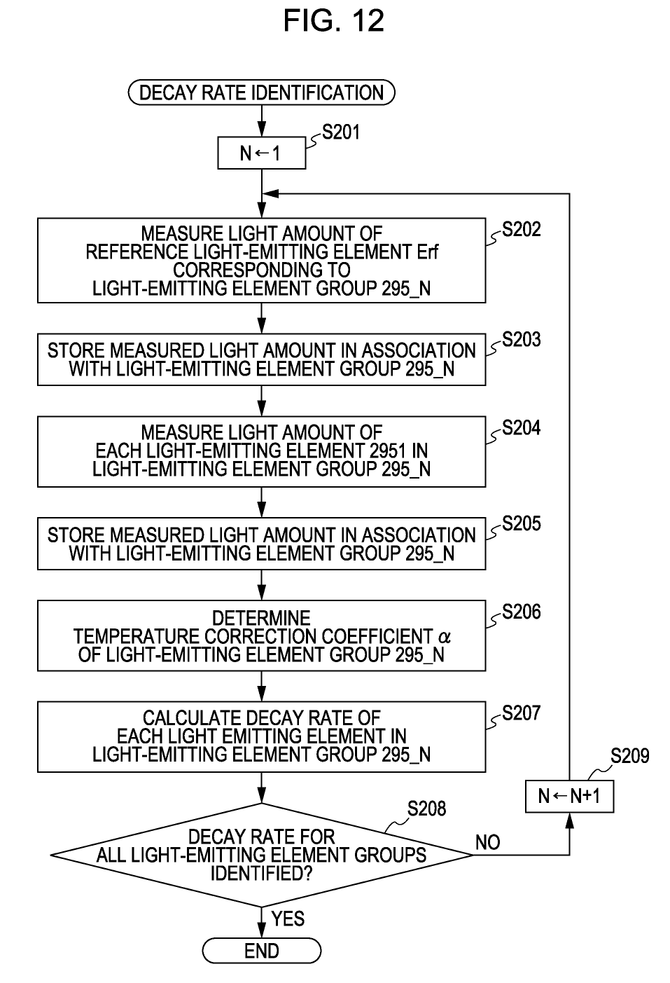

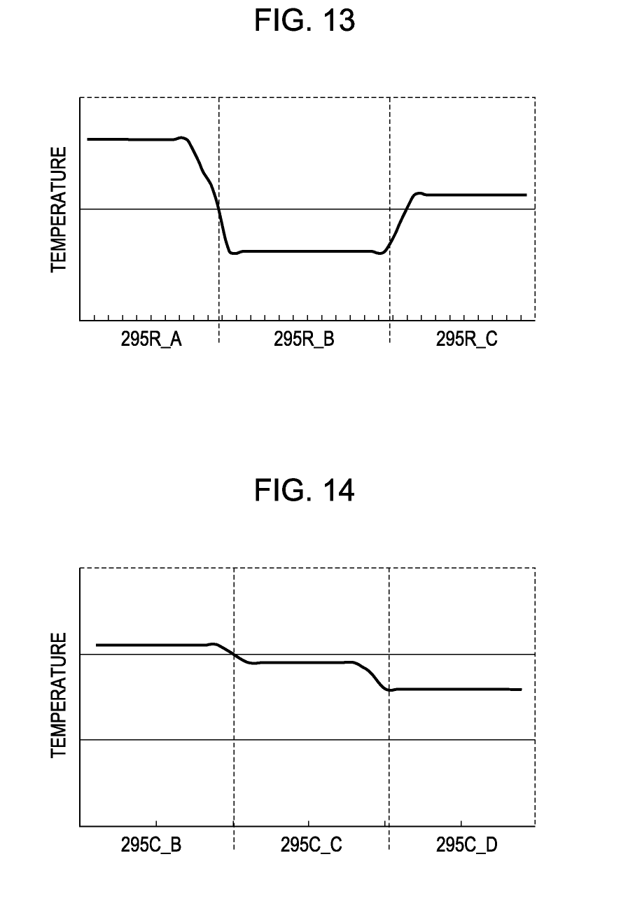

Incidentally, the light-emitting elements 2951 will decay as these exposure operations are repeated. Accordingly, in this embodiment, a decay rate indicating the degree to which the light-emitting elements 2951 have decayed is found, and the light amount of the light-emitting elements 2951 is controlled based on this decay rate. A light amount control technique according to this embodiment will be described hereinafter using FIGS. 11 and 12.

FIG. 11 is a flowchart illustrating a pre-shipping light amount measurement executed prior to shipping the line head. FIG. 12, meanwhile, is a flowchart illustrating decay rate identification executed at a predetermined timing following shipping. The decay rate identification for light-emitting elements will be described hereinafter using these flowcharts. Note that the operations described in these flowcharts are executed by the control circuit 55 controlling the various portions of the light emission control module LEC.

In the pre-shipping light amount measurement indicated in FIG. 11, the light amounts of the light-emitting elements 2951 and the reference elements Eref are measured for all of the light-emitting element groups 295_1, 295_2, and so on up to 295_N. More specifically, this is carried out as follows. In process S101 (hereinafter process S101, . . . up to process 209 are referred to simply as S101, . . . S209), 1 is substituted for a variable N. The variable N is a number added to the reference numeral 295 of each light-emitting element group following an underscore in order to identify that light-emitting element group 295. In S102, the reference elements Erf_1 and Erf_2 corresponding to the light-emitting element group 295_N are caused to emit light in sequence, and the light amounts of the reference elements Erf_1 and Erf_2 are detected by the light amount sensor SC. Then, the detected light amounts are stored in the memory 56 in association with the light-emitting element group 295_N (S103). Meanwhile, in S104, the light-emitting elements 2951 of the light-emitting element group 295_N are caused to emit light in sequence, and the light amounts of the light-emitting elements 2951 are detected by the light amount sensor SC. Then, the detected light amounts are stored in the memory 56 in association with the light-emitting element group 295_N (S105). In S106, it is determined whether or not the process for obtaining the light amounts executed in S102 to S105 has been completed for all the light-emitting element groups 295. In the case where the obtainment of light amounts has not been completed for all the light-emitting element groups 295 (“NO” in S106), the procedure advances to S107, where the variable N is incremented by 1 and the procedure returns to S102. On the other hand, in the case where the obtainment of light amounts has been completed for all the light-emitting element groups 295 (“YES” in S106), the pre-shipping light amount measurement ends.

In this embodiment, decay rate identification (a first process) is executed for the light-emitting elements 2951 at a post-shipping timing at which the line head 29 is not performing exposure operations (for example, between exposure operations) (FIG. 12). As with the pre-shipping light amount measurement, in the decay rate identification indicated in FIG. 12, the light amounts of the light-emitting elements 2951 and the reference elements Eref are measured for all of the light-emitting element groups 295_1, 295_2, and so on up to 295_N. More specifically, this is carried out as follows. In S201, 1 is substituted for a variable N. In S202, the reference elements Erf_1 and Erf_2 corresponding to the light-emitting element group 295_N are caused to emit light in sequence, and the light amounts of the reference elements Erf_1 and Erf_2 are detected by the light amount sensor SC. Then, the detected light amounts are stored in the memory 56 in association with the light-emitting element group 295_N (S203). Meanwhile, in S204, the light-emitting elements 2951 of the light-emitting element group 295_N are caused to emit light in sequence, and the light amounts of the light-emitting elements 2951 are detected by the light amount sensor SC. Then, the detected light amounts are stored in the memory 56 in association with the light-emitting element group 295_N (S205).

Note that in this embodiment, multiple light amount sensors SC are provided. Accordingly, the detected light amounts of the light-emitting elements 2951 or the reference elements Erf can be found by totaling the output values of the light amount sensors SC. However, the output value of the light amount sensor SC closest to the light-emitting elements 2951 or the reference elements Erf can be taken as the detected light amounts of those light-emitting elements 2951 or those reference elements Erf.

Next, a temperature correction coefficient α is determined based on the light amounts detected in S202 to S205 (S206). The decay rate of each light-emitting element 2951 is then found by multiplying the ratio between the pre- and post-shipping detected light amounts of a light-emitting element 2951 by the temperature correction coefficient α (S207). The principles of this decay rate identification are as follows.

A detected light amount Pa of the light-emitting elements 2951 found during the pre-shipping light amount detection can be expressed through the following formula:

(detected light amount Pa)=(light amount base value)×(incident distance coefficient)×(sensor gain) Formula 1

Note that the light amount base value is the light amount of a light-emitting element 2951 that has not decayed. The incident distance coefficient is a coefficient dependent on the distance from the light-emitting element 2951 to the light amount sensor SC, and corresponds to a damping rate at which the amount of the light emitted from the light-emitting element 2951 is dampened by the time it reaches the light amount sensor SC.

The sensor gain is the gain of the light amount sensor SC.

Meanwhile, a detected light amount Pb of a light-emitting element 2951 during the decay rate identification can be expressed through the following formula:

(detected light amount Pb)=(light amount base value)×(decay rate)×(incident distance coefficient)×(light-emitting element temperature fluctuation amount)×(sensor gain) Formula 2

Here, the light-emitting element temperature fluctuation amount of the light-emitting element 2951 whose decay rate is to be identified, found based on the difference in temperature between the pre-shipping light amount measurement and the decay rate identification. With past techniques, the ratio between the detected light amounts Pa and Pb was simply taken as the decay rate, and thus there were cases where the light-emitting element temperature fluctuation amount influenced the decay rate, making it difficult to accurately obtain the decay rate. In other words, with the past techniques, the detected light amount ratio was equivalent to the decay rate multiplied by the light-emitting element temperature fluctuation amount, and thus did not represent an accurate decay rate, as expressed by the following formula:

(detected light amount Pb)/(detected light amount Pa)=(decay rate)×(light-emitting element temperature fluctuation amount) Formula 3

As opposed to this, in this embodiment, the temperature correction coefficient α is found based on the detected light amount of the reference element Erf before and after shipping. In other words, the reference elements Erf are provided for each light-emitting element group 295, and are under approximately the same temperature as the light-emitting element group 295. Furthermore, the reference elements Erf are extinguished during exposure operations, and thus do not experience decay due to exposure operations. Accordingly, the ratio of detected light amounts Pa-rf and Pb-rf of the reference element Erf before and after shipping is expressed by the following formula:

(detected light amount Pb-rf)/(detected light amount Pa-rf)=(light-emitting element temperature fluctuation amount)=α Formula 4

Accordingly, in this embodiment, the decay rate of each light-emitting element 2951 is found based on the following formula, obtained by dividing Formula 3 by the temperature correction coefficient α:

(decay rate)=(detected light amount Pb)/(detected light amount Pa)/α Formula 5

Through this, it is possible to suppress the influence of temperature and obtain an accurate decay rate as a result.

In S208, it is determined whether or not the process for identifying the decay rate of each light-emitting element 2951 executed in S202 to S207 has been executed for all the light-emitting element groups 295. In the case where the decay rate identification has not been completed for all the light-emitting element groups 295 (“NO” in S208), the procedure advances to S209, where the variable N is incremented by 1 and the procedure returns to S202. On the other hand, in the case where the decay rate identification has been completed for all the light-emitting element groups 295 (“YES” in S208), the decay rate identification ends.

Note that as shown in FIG. 5, two reference elements Erf_1 and Erf_2 are provided for each light-emitting element group 295. Accordingly, the decay rates of the light-emitting elements 2951 in the light-emitting element row 2951R_1 are found based upon the temperature correction coefficient α found in turn based on a value obtained by averaging the values from the reference elements Erf_1 and Erf_2. Light-emitting elements emit heat as they emit light, and the temperature in the vicinity thereof increases as a result. Because the reference elements Erf are provided at both ends in the main scanning direction, temperature changes in the main scanning direction can be discovered, and using the temperature correction coefficient α found based on the reference elements Erf provided at both ends in the main scanning direction makes it possible to more accurately find the decay rate of the light-emitting elements 2951.

Furthermore, in the aforementioned embodiment, each light-emitting element group 295 is configured symmetrically, and the reference elements Erf are disposed symmetrically relative to the center of symmetry of the light-emitting element group 295. This configuration is particularly advantageous in ensuring that the reference elements Erf and the light-emitting element groups are at approximately the same temperature, thereby making it possible to obtain the decay rate of the light-emitting elements 2951 with higher accuracy. As a result, the line head 29 can execute favorable exposure operations.

Accordingly, in this embodiment, the decay rates (degrees of decay) of the light-emitting elements 2951 are found based on the light amounts of the reference elements Erf and the light-emitting elements 2951. The reference elements Erf are provided for each light-emitting element group 295, and are under approximately the same temperature as the light-emitting element group 295. Furthermore, the reference elements Erf are extinguished during exposure operations, and thus do not experience decay due to exposure operations. In other words, in this embodiment, using the light amounts of the reference elements Erf, which are under approximately the same temperature as the light-emitting element group 295 and also do not decay, makes it possible to accurately find the decay rates of the light-emitting elements 2951 in the light-emitting element group 295, while the same time suppressing the influence of temperature. Accordingly, controlling the light amounts of the light-emitting elements 2951 based on these decay rates makes it possible for the line head 29 (exposure head) to suppress fluctuations in the light amounts of the light-emitting elements 2951 caused by decay and execute favorable exposures. Furthermore, using such a line head 29 makes it possible for the image forming apparatus to form a favorable image.

Meanwhile, in this embodiment, the multiple reference elements Erf are, within corresponding multiple light-emitting elements 2951, either the closest reference elements Erf to the light-emitting elements at the upstream end in the main scanning direction MD or the reference elements Erf closest to the light-emitting elements at the downstream end in the main scanning direction MD, and the decay rates of the light-emitting elements 2951 are found based on these reference elements Erf. Through this, the following effects are achieved. Heat is emitted by the light-emitting elements 2951 as a result of light emission, and the temperature rises. If the light emission/extinguishment is off-balance within a light-emitting element group 295, there is the possibility that a temperature difference will arise in that light-emitting element group 295. The following is an example thereof. FIG. 5B illustrates the temperature distribution in a light-emitting element group. As shown in FIG. 5B, the light-emitting elements 2951 in the left half of the light-emitting element group 295 emit light while the light-emitting elements 2951 in the right half are extinguished, and thus the temperature distribution drops off toward the right within the light-emitting element group 295. As shown in FIG. 5A, the reference element Erf_1 is located at one end in the lengthwise direction LGD of the light-emitting element row 2951R_1 in the light-emitting element group 295 (in FIG. 5A, the left end). Meanwhile, the reference element Erf_2 is located at the other end in the lengthwise direction LGD of the light-emitting element row 2951R_2 in the light-emitting element group 295 (in FIG. 5A, the right end). In FIG. 5B, the circular marks indicate the positions of the reference elements Erf_1 and Erf_2. A dotted line Tave in FIG. 5B indicates the average temperature of the reference elements Erf_1 and Erf_2. If the decay rates of the light-emitting elements 2951 within the light-emitting element group 295 is found from the reference elements Erf_1 and Erf_2, the average temperature Tave is closer to the temperatures of the light-emitting elements 2951, thus making it possible to accurately control the light amounts and execute favorable exposures.

This embodiment is applied in and suited to the line head 29, in which the light-emitting elements 2951 and the reference elements Erf are organic EL elements. The reason for this is that the light amounts of organic EL elements fluctuate depending on decay and changes in temperature, and this embodiment is suited to accurately finding the degree of decay in the light-emitting elements 2951 and realizing favorable exposure operations thereby.

Accordingly, in this embodiment, the line head 29 corresponds to an “exposure head”; the light-emitting element group 295 corresponds to “multiple light-emitting elements”; the light emission control module LEC corresponds to a “control unit”; the decay rate corresponds to a “degree of decay”; and the photosensitive drum 21 corresponds to a “latent image bearing member”. The memory 56, meanwhile, corresponds to a “storage unit”.

Note that the invention is not limited to the aforementioned embodiment, and various modifications can be added to the aforementioned embodiment without departing from the essential spirit thereof. For example, the aforementioned embodiment assumes a light amount sensor SC having a comparatively low sensor output temperature fluctuation. However, the decay rate can be found accurately even if a light amount sensor SC having a high sensor output of temperature fluctuation is used. Specifically, the decay rate may be found in the following manner.

In the case where the sensor output temperature fluctuation is high, the detected light amount Pb of a light-emitting element 2951 during the decay rate identification can be expressed through the following formula:

(detected light amount Pb)=(light amount base value)×(decay rate)×(incident distance coefficient)×(light-emitting element temperature fluctuation amount)×(sensor gain)×(sensor temperature fluctuation amount) Formula 6

Here, the sensor temperature fluctuation amount is the amount of fluctuation in the output values of the light amount sensor SC based on the difference in temperature between the pre-shipping light amount measurement and the decay rate identification. In this case, the ratio of the detected light amounts Pa and Pb is equivalent to the amount of the light-emitting element temperature fluctuation amount and the sensor temperature fluctuation amount multiplied by the decay rate.

(detected light amount Pb)/(detected light amount Pa)=(decay rate)×(light-emitting element temperature fluctuation amount)×(sensor temperature fluctuation amount) Formula 7

Accordingly, the temperature correction coefficient α is found based on the detected light amount of the reference elements Erf before and after shipping. In other words, the reference elements Erf are provided for each light-emitting element group 295, and are under approximately the same temperature as the light-emitting element group 295. Furthermore, the reference elements are extinguished during exposure operations, and thus do not experience decay due to exposure operations. Accordingly, the ratio of detected light amounts Pa-rf and Pb-rf of the reference element Erf before and after shipping is expressed by the following formula:

(detected light amount Pb-rf)/(detected light amount Pa-rf)=(light-emitting element temperature fluctuation amount)×(sensor temperature fluctuation amount)=α Formula 8

Accordingly, the decay rate of each light-emitting element 2951 is found based on the following formula, obtained by dividing Formula 7 by the temperature correction coefficient α:

(decay rate)=(detected light amount Pb)/(detected light amount Pa)/α Formula 9

This makes it possible to suppress the influence of temperature and obtain an accurate decay rate as a result.

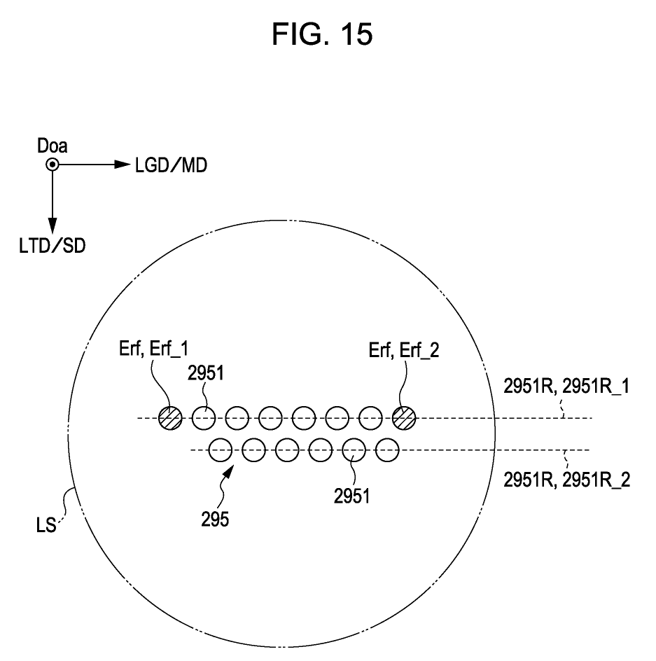

Furthermore, in the present embodiment, the reference element Erf 1 may be located at one end side in the lengthwise direction LGD of the light-emitting element row 2951R_1 in the light-emitting element group 295 (in FIG. 15, the left end), whereas the reference element Erf_2 may be located at the other end side in the lengthwise direction LGD of the light-emitting element row 2951R_1 in the light-emitting element group 295 (in FIG. 15, the right end), as shown in FIG. 15.

Although three light-emitting element group rows 295R are provided in the stated embodiment, the number of light-emitting element group rows 295R is not limited thereto.

In addition, although each light-emitting element group 295 is configured of two light-emitting element rows 2951R in the stated embodiment, the number of light-emitting element rows 2951R of which the light-emitting element group 295 is configured is not limited thereto.

In addition, although the light-emitting element row 2951R is configured of seven light-emitting elements 2951 in the stated embodiment, the number of light-emitting elements 2951 of which the light-emitting element row 2951R is configured is not limited thereto.

In addition, although the number of light-emitting elements 2951 is equal in all light-emitting element rows 2951R in the stated embodiment, the number of light-emitting elements 2951 can be changed in each light-emitting element row 2951R.

Finally, although bottom emission-type organic EL elements are used as the light-emitting elements 2951 and the reference elements Erf in the stated embodiment, top emission-type organic EL elements, LEDs (Light Emitting Diodes), or the like can be used instead.

The entire disclosure of Japanese Patent Applications No. 2009-088728, filed on Apr. 1, 2009 is expressly incorporated by reference herein.

What is claimed is:

1. An exposure head comprising:
a light-emitting element;
an image formation optical system that forms an image of light from the light-emitting element;
multiple reference elements disposed relative to the light-emitting element; and
a control unit that controls the light emission of the light-emitting element and extinguishes the reference elements during a latent image formation operation,
wherein the control unit finds the degree of decay of the light-emitting element based on the light amounts of the light-emitting element and the multiple reference elements at a time when the latent image formation operation is not being carried out, and controls the light amount of the light-emitting element during the latent image formation operation based on the degree of decay.

2. The exposure head according to claim 1,
wherein the exposure head includes multiple light-emitting elements, the multiple light-emitting elements being disposed across a distance that is longer in a first direction than in a second direction and being disposed symmetrically; and
the multiple reference elements are disposed on the outer sides of corresponding light-emitting elements in the first direction, and are disposed symmetrically relative to the center of symmetry of the multiple light-emitting elements.

3. The exposure head according to claim 1, wherein the light-emitting element and the reference elements are organic EL elements.

4. A control method for an exposure head, the method comprising:
causing a light-emitting element and multiple reference elements disposed in the exposure head to emit light, and finding the degree of decay of the light-emitting element based on the light amounts of the light-emitting element and the multiple reference elements; and
executing a latent image formation operation, in which light from the light-emitting element is formed an image by an image formation optical system and a latent image is formed upon a latent image bearing member, while controlling the light amount of the light-emitting element based on the degree of decay, and extinguishing the multiple reference elements during the latent image formation operation.

5. An image forming apparatus comprising:
a latent image bearing member;
an exposure head including a light-emitting element, an image formation optical system that forms an image of light from the light-emitting element and exposes the latent image bearing member, and multiple reference elements disposed relative to the light-emitting element; and
a control unit that controls the light emission of the light-emitting element during a latent image formation operation in which a latent image is formed on the latent image bearing member and extinguishes the multiple reference elements during the latent image formation operation,
wherein the control unit finds the degree of decay of the light-emitting element based on the light amounts of the light-emitting element and the multiple reference elements which are caused to emit light at a time when the latent image formation operation is not being carried out, and controls the light amount of the light-emitting element during the latent image formation operation based on the degree of decay.
